(19) United States
(12) Patent Application Publication
(10) Pub. No.: US 2025/0095201 A1
(43) Pub. Date: Mar. 20, 2025

(54) MACHINE-LEARNING BASED OBJECT LOCALIZATION FROM IMAGES

(71) Applicant: QUALCOMM Incorporated, San Diego, CA (US)

(72) Inventors: Ori Shental, Marlboro, NJ (US); Ashwin Sampath, Skillman, NJ (US); Michael Dimare, Morristown, NJ (US); Junyi Li, Fairless Hills, PA (US); Thomas Joseph Richardson, South Orange, NJ (US); Muhammad Nazmul Islam, Littleton, MA (US); Michael Ethan Berkowitz, New York, NY (US)

(21) Appl. No.: 18/467,993

(22) Filed: Sep. 15, 2023

(51) Int. Cl. G06T 7/73; G06T 7/11; G06T 7/50

(52) U.S. Cl. CPC G06T 7/74; G06T 7/11; G06T 7/50; G06T 2207/10032; G06T 2207/20081

(57) ABSTRACT

A method includes retrieving a plurality of images containing one or more objects of interest and generating, with one or more processors, using a machine learning model, a bounding box around each of the one or more objects of interest for each of the plurality of images. The method also includes determining, with the one or more processors, a geographical position of each of the one or more objects of interest based on a position of the bounding box.

### TECHNICAL FIELD

This disclosure relates to object localization.

### BACKGROUND

A digital twin is a virtual representation of a physical object or system. Digital twins may be used to simulate the behavior of the physical object or system, and to test different scenarios. Digital twins are becoming increasingly important for a variety of applications. The accuracy of a digital twin directly impacts the effectiveness. If the digital twin is not accurate, then it may not be able to accurately simulate the behavior of the physical object or system. Such inaccuracies may lead to inaccurate results, which may in turn lead to poor decision-making.

Not having prior knowledge of the objects' locations is a common challenge in digital twin localization because it may be difficult and time-consuming to manually collect the data needed to create a database of object placements. Additionally, the data that is collected may not be accurate. The database of object placements being outdated or missing is another common challenge in digital twin localization. Outdated database may happen for a variety of reasons, such as changes to the physical environment or the loss of data. When the database is outdated or missing, it may lead to erroneous scenes in the digital twin. These challenges may make it difficult to create accurate digital twins.

### SUMMARY

In general, this disclosure describes techniques for object localization using machine learning algorithms. The disclosed techniques may be used to localize objects in aerial satellite and Light Detection and Ranging (LIDAR) sensor images, as well as street-level images. The disclosed techniques are synergistic and complementary. In other words, the disclosed techniques may leverage both aerial and street-level images to improve the accuracy of object localization. The disclosed techniques may first extract features from the aerial and street-level images. The extracted features may be based on the appearance of the object, the context in which the object is located, or the location of the object relative to other objects. The features may then be used to train a machine learning model. The machine learning model may learn to associate the features with the location of the object in the image.

Once the machine learning model is trained, it may be used to localize objects in new images. The machine learning model may be used to localize objects in either multiple images or a single image. The present disclosure provides example techniques for object localization that may be used with a variety of image sources. Accordingly, the disclosed techniques may be more applicable to a wider range of applications. In other words, the disclosed techniques may be used in a variety of applications, such as, but not limited to, self-driving vehicles, security systems, and medical imaging.

In one example, a method includes retrieving a plurality of images containing one or more objects of interest and generating, with one or more processors, using a machine learning model, a bounding box around each of the one or more objects of interest for each of the plurality of images. The method also includes determining, with the one or more processors, a geographical position of each of the one or more objects of interest based on a position of the bounding box.

In another example, an apparatus for object localization includes a memory for storing a plurality of images containing one or more objects of interest; and processing circuitry in communication with the memory. The processing circuitry is configured to retrieve the plurality of images containing the one or more objects of interest and generate, using a machine learning model, a bounding box around each of the one or more objects of interest for each of the plurality of images. The processing circuitry is also configured to determine a geographical position of each of the one or more objects of interest based on a position of the bounding box.

In another example, a computer-readable medium includes instructions that, when applied by processing circuitry, cause the processing circuitry to: retrieve the plurality of images containing the one or more objects of interest and generate, using a machine learning model, a bounding box around each of the one or more objects of interest for each of the plurality of images. Additionally, the instructions cause the processing circuitry to determine a geographical position of each of the one or more objects of interest based on a position of the bounding box.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example system that may perform the techniques of this disclosure.

FIG. 2 is a block diagram illustrating an example street object localization framework that may perform the techniques of this disclosure.

FIG. 3 is a block diagram illustrating an exemplary processing flow in accordance with the techniques of this disclosure.

FIGS. 4A and 4B are diagrams illustrating an example of aerial screening in accordance with the techniques of this disclosure.

FIGS. 5A-5D are diagrams illustrating an example of street level view reinforcement in accordance with the techniques of this disclosure.

FIGS. 6A-6D are diagrams illustrating an example of single image localization in accordance with the techniques of this disclosure.

FIG. 7 is a flowchart illustrating an example method for classifying soiled regions in an image in accordance with the techniques of this disclosure.

### DETAILED DESCRIPTION

Automated creation of authentic digital twins are useful in reliably bridging from the physical world into digital and virtual representations of the physical world. A digital twin is a virtual representation of a physical object or system. Digital twins may be used to simulate behaviors of the physical objects or systems, and to predict how they will react to changes in the environment. Digital twins are becoming increasingly important for a variety of applications, such as, but not limited to, product design and development, manufacturing, operation and maintenance, safety and risk assessment. For example, digital twins may be used to simulate the performance of a product in its intended environment, which may help to identify potential problems and optimize the design. As another example, digital twins may be used to optimize manufacturing processes, such as by scheduling production runs to minimize waste and maximize efficiency. As yet another non-limiting example, digital twins may be used to monitor the performance of physical assets, and to identify potential problems before they cause outages or other disruptions.

The accuracy of a digital twin impacts its usefulness. If the digital twin is not accurate, it may not be able to accurately simulate the behavior of the physical object or system. Inaccuracy of digital twins may lead to problems such as, but not limited to, incorrect predictions, ineffective optimization, and unsafe operation. If the digital twin predicts that the physical object or system will behave in a certain way, but the physical object actually behaves in a different way, this inaccuracy may lead to incorrect decisions being made. If the digital twin is not accurate, it may not be able to effectively optimize processes or identify potential problems. If the digital twin is not accurate, it may not be able to identify potential risks, which could lead to unsafe operations.

The digital twins' accuracy is not only essential for XR (extended Reality)/Metaverse-related applications but also for communication network assisting and planning tools, especially in the higher frequency bands, like mmW and beyond. XR/Metaverse-related applications are immersive experiences that blend the real and virtual worlds. Such applications may require accurate digital twins of the physical environment in order to provide a realistic experience. Communication network assisting and planning tools may use digital twins to simulate the performance of communication networks. Such tools may require accurate digital twins in order to make accurate predictions about the performance of the networks.

Hence, the correct localization (i.e., latitude, longitude, and possibly also height) of physical objects within the digital twin is an important step for building accurate proxies of the real-world scenery. The correct localization of physical objects within the digital twin may be needed for ensuring that the digital twin is accurate. If the physical objects are not correctly localized, the digital twin may not be able to accurately simulate their behavior. Inaccurate simulation may lead to problems such as incorrect predictions, ineffective optimization, and unsafe operations.

Not having prior knowledge of the objects' locations is a common challenge in digital twin localization. Lack of prior knowledge of the objects' locations may lead to erroneous scene understanding. In an aspect, the present disclosure provides a solution to this challenge by using an integrated set of different types of images. The different types of images may include but are not limited to: aerial imagery (e.g., satellite images, LIDAR sensor images) and multiple or single street-level images. By using multiple types of images, the disclosed techniques may obtain more information about the scene and make more accurate inferences about the position of street objects.

In addition, the disclosed techniques may include an optional step of validating and reinforcing semi-accurate positioning based on available Geographic Information System (GIS) databases. Such validation may be done by comparing the inferred position of street objects to the position of street objects in the GIS database. If the inferred position is close to the position in the GIS database, then a disclosed system may be confident that the inferred position is accurate. Advantageously, the disclosed technique may reliably and holistically localize street objects from an integrated set of different types of images. Such techniques are a promising approach for improving the accuracy of scene understanding and for enabling a variety of applications, such as autonomous driving, augmented reality, and urban planning. Some of the challenges that may need to be addressed in order to reliably and holistically localize street objects from an integrated set of different types of images may include but are not limited to: image registration, object detection, object localization, and street understanding. Accordingly, the position of each street object may need to be localized in each of the images.

In an aspect, the present disclosure proposes techniques for object localization using machine learning algorithms. The disclosed techniques may be used to localize objects in aerial satellite images and LIDAR sensor images, as well as street-level images. The techniques may leverage both aerial and street-level images to improve the accuracy of object localization. In an aspect, the machine learning system may extract features from the aerial and street-level images. These features may be based on the appearance of the object, the context in which the object is located, or the location of the object relative to other objects. For example, the machine learning system may extract features from the aerial image that are related to the shape, size, and color of the object. It may also extract features from the street-level image that are related to the object's surroundings, such as the type of terrain, the presence of other objects, and the lighting conditions.

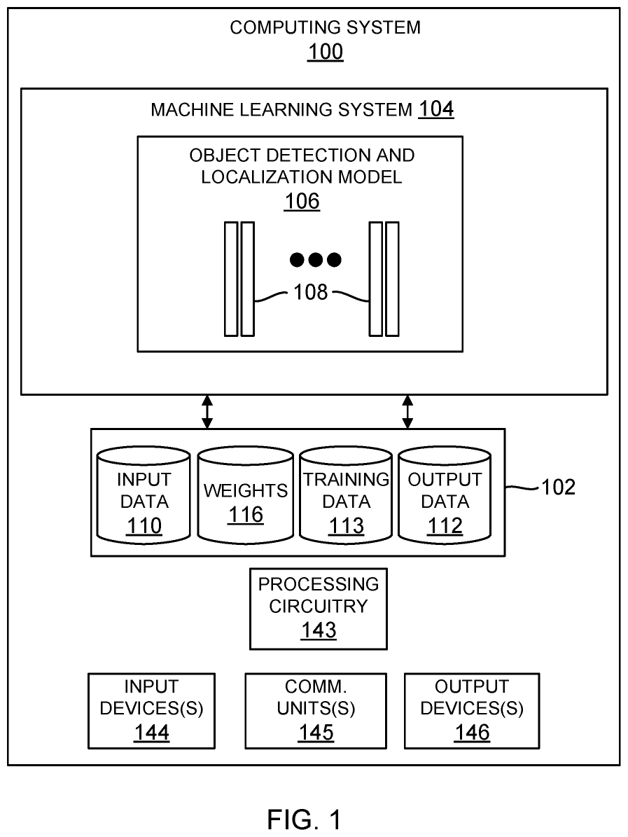

FIG. 1 is a block diagram illustrating an example computing system 100. As shown, computing system 100 comprises processing circuitry 143 and memory 102 for executing a machine learning system 104. In an aspect, machine learning system 104 may include one or more neural networks, such as, such as object detection and localization model 106 (also referred to herein as, “machine learning model 106”) comprising layers 108. The machine learning model 106 may comprise any of various types of neural networks, such as, but not limited to, recursive neural networks (RNNs), convolutional neural networks (CNNs), and deep neural networks (DNNs).

Computing system 100 may also be implemented as any suitable external computing system, such as one or more server computers, workstations, laptops, mainframes, appliances, cloud computing systems, High-Performance Computing (HPC) systems (i.e., supercomputing) and/or other computing systems that may be capable of performing operations and/or functions described in accordance with one or more aspects of the present disclosure. In some examples, computing system 100 may represent a cloud computing system, server farm, and/or server cluster (or portion thereof) that provides services to client devices and other devices or systems. In other examples, computing system 100 may represent or be implemented through one or more virtualized compute instances (e.g., virtual machines, containers, etc.) of a data center, cloud computing system, server farm, and/or server cluster.

The techniques described in this disclosure may be implemented, at least in part, in hardware, software, firmware or any combination thereof. For example, various aspects of the described techniques may be implemented within processing circuitry 143 of computing system 100, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

In another example, computing system 100 comprises any suitable computing system having one or more computing devices, such as desktop computers, laptop computers, gaming consoles, smart televisions, handheld devices, tablets, mobile telephones, smartphones, etc. In some examples, at least a portion of computing system 100 is distributed across a cloud computing system, a data center, or across a network, such as the Internet, another public or private communications network, for instance, broadband, cellular, Wi-Fi, ZigBee, Bluetooth® (or other personal area network-PAN), Near-Field Communication (NFC), ultrawideband, satellite, enterprise, service provider and/or other types of communication networks, for transmitting data between computing systems, servers, and computing devices.

Memory 102 may comprise one or more storage devices. One or more components of computing system 100 (e.g., processing circuitry 143, memory 102, object detection and localization model 106, etc.) may be interconnected to enable inter-component communications (physically, communicatively, and/or operatively). In some examples, such connectivity may be provided by a system bus, a network connection, an inter-process communication data structure, local area network, wide area network, or any other method for communicating data. Processing circuitry 143 of computing system 100 may implement functionality and/or execute instructions associated with computing system 100. Examples of processing circuitry 143 include microprocessors, application processors, display controllers, auxiliary processors, one or more sensor hubs, and any other hardware configured to function as a processor, a processing unit, or a processing device. Computing system 100 may use processing circuitry 143 to perform operations in accordance with one or more aspects of the present disclosure using software, hardware, firmware, or a mixture of hardware, software, and firmware residing in and/or executing at computing system 100. The one or more storage devices of memory 102 may be distributed among multiple devices.

Memory 102 may store information for processing during operation of computing system 100. In some examples, memory 102 comprises temporary memories, meaning that a primary purpose of the one or more storage devices of memory 102 is not long-term storage. Memory 102 may be configured for short-term storage of information as volatile memory and therefore not retain stored contents if deactivated. Examples of volatile memories include random access memories (RAM), dynamic random-access memories (DRAM), static random-access memories (SRAM), and other forms of volatile memories known in the art. Memory 102, in some examples, may also include one or more computer-readable storage media. Memory 102 may be configured to store larger amounts of information than volatile memory. Memory 102 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories. Memory 102 may store program instructions and/or data associated with one or more of the modules described in accordance with one or more aspects of this disclosure.

Processing circuitry 143 and memory 102 may provide an operating environment or platform for one or more modules or units (e.g., object detection and localization model 106), which may be implemented as software, but may in some examples include any combination of hardware, firmware, and software. Processing circuitry 143 may execute instructions and the one or more storage devices, e.g., memory 102, may store instructions and/or data of one or more modules. The combination of processing circuitry 143 and memory 102 may retrieve, store, and/or execute the instructions and/or data of one or more applications, modules, or software. The processing circuitry 143 and/or memory 102 may also be operably coupled to one or more other software and/or hardware components, including, but not limited to, one or more of the components illustrated in FIG. 1.

Processing circuitry 143 may execute machine learning system 104 using virtualization modules, such as a virtual machine or container executing on underlying hardware. One or more of such modules may execute as one or more services of an operating system or computing platform. Aspects of machine learning system 104 may execute as one or more executable programs at an application layer of a computing platform.

One or more input devices 144 of computing system 100 may generate, receive, or process input. Such input may include input from a keyboard, pointing device, voice responsive system, video camera, biometric detection/response system, button, sensor, mobile device, control pad, microphone, presence-sensitive screen, network, or any other type of device for detecting input from a human or machine.

One or more output devices 146 may generate, transmit, or process output. Examples of output are visual, video, tactile, and/or audio output. Output devices 146 may include a display, sound card, video graphics adapter card, speaker, presence-sensitive screen, one or more USB interfaces, video and/or audio output interfaces, or any other type of device capable of generating tactile, audio, video, or other output. Output devices 146 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 100 may include a presence-sensitive display that may serve as a user interface device that operates both as one or more input devices 144 and one or more output devices 146.

One or more communication units 145 of computing system 100 may communicate with devices external to computing system 100 (or among separate computing devices of computing system 100) by transmitting and/or receiving data, and may operate, in some respects, as both an input device and an output device. In some examples, communication units 145 may communicate with other devices over a network. In other examples, communication units 145 may send and/or receive radio signals on a radio network such as a cellular radio network. Examples of communication units 145 include a network interface card (e.g., such as an Ethernet card), an optical transceiver, a radio frequency transceiver, a GPS receiver, or any other type of device that can send and/or receive information. Other examples of communication units 145 may include Bluetooth®, GPS, 3G, 4G, and Wi-Fi® radios found in mobile devices as well as Universal Serial Bus (USB) controllers and the like.

In the example of FIG. 1, object detection and localization model 106 may receive input data 110 and may generate output data 112. Input data 110 and output data 112 may contain various types of information. For example, input data 110 may include multimodal data. The term “multimodal data” or “multimodal information” is used herein to refer to information that may be composed of a plurality of media or data types such as, but not limited to, image data, video data, audio data, source text data, numerical data, speech data, and so on. Output data 112 may include geographical position data, such as GPS coordinates, and other examples of geographical position data.

Each set of layers 108 may include a respective set of artificial neurons. Layers 108, for example, may include an input layer, a feature layer, an output layer, and one or more hidden layers. Layers 108 may include fully connected layers, convolutional layers, pooling layers, and/or other types of layers. In a fully connected layer, the output of each neuron of a previous layer forms an input of each neuron of the fully connected layer. In a convolutional layer, each neuron of the convolutional layer processes input from neurons associated with the neuron's receptive field. Pooling layers combine the outputs of neuron clusters at one layer into a single neuron in the next layer.

Each input of each artificial neuron in each layer of the sets of layers 108 is associated with a corresponding weight in weights 116. The output of the k-th artificial neuron in neural network 106 may be defined as:

$${y}_{k} = ϕ ( {W}_{k} \cdot {X}_{k} ) \qquad ( 1 )$$

In Equation (1), yₖ is the output of the k-th artificial neuron, ϕ(·) is an activation function, Wₖ is a vector of weights for the k-th artificial neuron (e.g., weights in weights 116), and Xₖ is a vector of value of inputs to the k-th artificial neuron. In some examples, one or more of the inputs to the k-th artificial neuron is a bias term that is not an output value of another artificial neuron or based on source data. Various activation functions may be used, such as Rectified Linear Unit (ReLU), TanH, Sigmoid, and so on.

Machine learning system 104 may comprise a pre-trained model that is trained using training data 113, in accordance with techniques described herein. In an aspect, object detection and localization model 106 may be a type of machine learning model that is configured to find and locate objects in an image or video. The object detection and localization model 106 may be trained on a large dataset of images that have been manually labeled with the location and class of each object (training data 113).

Once trained, the detection and localization model 106 may be used to detect and localize objects in new images or videos. There are two main types of object detection and localization models: single-stage detectors and two stage detectors. Single-stage detectors are typically faster than two-stage detectors, but they are also less accurate. Single-stage detectors typically use a single neural network to predict the bounding boxes and class labels for all objects in an image. Two-stage detectors are typically more accurate than single-stage detectors, but they are also slower. Two-stage detectors typically use two neural networks: one to predict the rough location of objects in an image, and another to refine the bounding boxes and class labels. Some examples of object detection and localization models may include but are not limited to: You Only Look Once (YOLO), Single Shot Detector (SSD), Faster R-CNN, Mask R-CNN, and the like. YOLO is a single-stage detector that is known for its speed and accuracy. YOLO may detect up to 91 different object classes in real time.

The correct placement of physical objects within a digital twin is important for building accurate proxies of the real-world scenery. The location of objects in the real world may affect their behavior and interactions with other objects. For example, the location of a building may affect the propagation of radio waves, and the location of a tree may affect the wind patterns in an area. However, at least in some cases it may be difficult to obtain prior knowledge of the objects' locations. For example, the database of object placements in hand (e.g., based on GIS and commercial sources, or from local municipalities) may be outdated or missing. Lack of accurate data may result in erroneous scenes in the digital twin, which, in turn, may lead to inaccurate predictions and decision-making. There are a number of different methods that may be used to determine the correct placement of physical objects within a digital twin. Such methods may include but are not limited to: object detection and localization, GIS data, and user input. Object detection and localization methods may be used by the detection and localization model 106 to identify and locate objects in images or videos. Such information can then be used to place the objects in the digital twin.

In an aspect, it may be possible to reliably and holistically localize a street object from an integrated set of different types of images. Such localization may be performed using a variety of methods, including, but not limited to: object detection and localization, image registration, feature matching, machine learning, and the like. The detection and localization model 106 may be used to identify and locate objects in images or videos. Such information may then be used to localize the street object in the integrated set of images.

Machine learning methods may be used to learn the relationship between the different types of images and the location of street objects. In an aspect, a machine learning system may use learned information to localize street objects in new images. The choice of method for localizing street objects from an integrated set of images may depend on the specific application. The integration of different types of images may improve the accuracy of localization of street objects because different types of images may provide complementary information about the location of objects. For example, aerial images may provide information about the overall layout of an area, while street-level images may provide information about the details of objects in the area. In an aspect, a machine learning system may perform an optional step of validating and reinforcing semi-accurate positioning based on available GIS databases. Such step may further improve the accuracy of localization of street objects. In an aspect, GIS databases can provide accurate information about the location of objects in the real world. By comparing the semi-accurate positioning of objects in the images to the accurate information in the GIS databases, a machine learning system may improve the accuracy of the localization of objects.

In summary, the detection and localization model 106 may retrieve a plurality of images containing one or more objects of interest and may generate a bounding box around each of the one or more objects of interest for each of the plurality of images. Additionally, the detection and localization model 106 may determine a geographical position of each of the one or more objects of interest based on a position of the bounding box using one or more of the plurality of images, as described below.

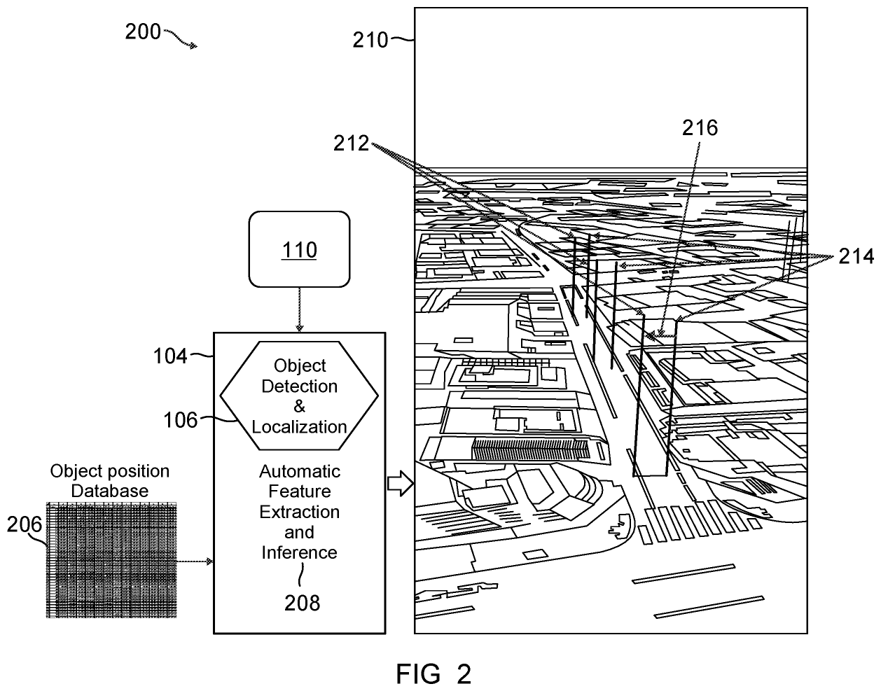

FIG. 2 is a block diagram illustrating an example street object localization framework that may perform the techniques of this disclosure. FIG. 2 is provided for purposes of explanation and should not be considered limiting of the techniques as broadly exemplified and described in this disclosure.

The accuracy of a digital twin impacts its usefulness. If the digital twin is not accurate, it may not be able to accurately simulate the behavior of the physical object or system. Inaccuracy of digital twins may lead to problems such as, but not limited to: incorrect predictions, ineffective optimization, unsafe operations, and the like. If the digital twin predicts that the physical object or system may behave in a certain way, but the physical object or system actually behaves in a different way, such error may lead to incorrect decisions being made. If the digital twin is not accurate, the digital twin may not be able to effectively optimize processes or identify potential problems. If the digital twin is not accurate, the digital twin may not be able to identify potential risks, which could lead to unsafe operations. Automated creation of authentic digital twins are useful in reliably bridging from the physical world into digital and virtual representations of the physical world. Automated creation may help to ensure that the digital twin is accurate. Automated creation may also help to reduce the time and cost associated with creating digital twins. There are a number of different methods that may be used for automated creation of digital twins. Such methods may include, but are not limited to, data acquisition, data processing, modelling and validation. Data acquisition involves collecting data about the physical object or system. Such data may be collected using a variety of sensors, such as, but not limited to, cameras, LIDAR sensors, and radar sensors. Data processing involves cleaning, transforming, and analyzing the data collected during data acquisition. Processed data may be used to create a digital representation of the physical object or system. Modeling involves creating a machine learning model of the physical object or system. Such machine learning model may be used to simulate the behavior of the physical object or system.

For purposes of explanation, this disclosure describes an example street object localization framework 200 illustrated in FIG. 2 that may perform one or more machine learning algorithms for object localization and/or object database position records adjustment based on a plethora of widely available images. These images may include aerial satellite and LIDAR images on one hand, and street-level images on the other hand. The proposed machine learning system 104 may include a synergetic and complementary approach for object localization based on both aerial (top view) images and street-level images, based on either multiple or single image data in a given geographical area of interest.

In the example of FIG. 2, the disclosed machine learning system 104 may first extract features from the aerial and street-level images. The extracted features may be based on the appearance of the object, the context in which the object is located, or the location of the object relative to other objects. The extracted features may then be used to train the object detection and localization model 106. The object detection and localization model 106 may learn to associate the features with the location of the object in the image. Once the object detection and localization model 106 is trained, the machine learning model 104 may be used to localize objects in new images. The object detection and localization model 106 may be used to localize objects in either multiple images or a single image. The proposed methodology is synergetic and complementary because it integrates information from both aerial and street-level images. By integrating information from both types of images, the object detection and localization model 106 may achieve higher accuracy in object localization.

In the example of FIG. 2, a specific use case for localization and generation of a digital twin for a street are discussed in more detail herein. However, the present disclosure is not limited to the described use case. The disclosed techniques are suitable for a variety of applications, such as, but not limited to: autonomous driving, augmented reality, and urban planning. For example, the described techniques may be used to localize objects on the road, such as cars, pedestrians, and traffic lights. Such localization information may be used to help autonomous vehicles navigate safely. As another example, the described techniques may be used to localize objects in the real world, such as landmarks and products. Such localization information may be used to overlay augmented reality content on top of the real world. As yet another non-limiting example, the described techniques may be used to localize objects in a city, such as buildings and parks. Such localization information may be used to help urban planners make decisions about land use and infrastructure.

In the context of the vertical poles use case, it should be noted that vertical poles (e.g., utility poles, street lampposts, traffic lights, and the like) are very good potential bearers of transceiver units in the required densification towards successful deployment of 5G/6G mmW networks. Such vertical poles are typically tall and sturdy, and they are often located in areas with high foot traffic or vehicular traffic. The accurate localization of vertical poles may be important for a number of reasons. First, the accurate localization allows for the efficient deployment of transceiver units. By knowing the exact location of vertical poles, the amount of time and resources required to install and maintain transceiver units may be minimized. Second, accurate localization of vertical poles may improve the performance of 5G/6G mmW networks. By knowing the exact location of vertical poles, the transmission and reception of signals may be optimized, which may lead to improved data rates, reduced latency, and increased coverage. Third, accurate localization of vertical poles may be used to create digital twins of communication networks. Digital twins are virtual representations of physical systems that may be used to simulate the behavior of the physical system. By creating a digital twin of a communication network, it is possible to test new configurations and optimize the performance of the network without having to make changes to the physical network. Overall, accurate localization of vertical poles is an important layer in the creation of a digital twin serving. For example, accurate localization of vertical poles may be important in any communication assisting and planning application. Accurate localization may help to improve the efficiency, performance, and security of 5G/6G mmW networks.

In an aspect, the disclosed framework 200 may be used to locate objects and/or adjust records in the object database position 206 in a number of ways. As noted above, the object detection and localization model 106 may identify and locate objects in images or videos. Once an object has been detected, object's geographical position may be estimated. As used herein, the term “geographical position” may refer to planar latitude and longitude; however, other ways to identify geographical position are possible. Based on the estimated geographical position, the object detection and localization model 106 may then adjust the object's geographical position in the object position database 206. In an aspect, the object detection and localization model 106 may be configured to learn the relationship between the appearance of an object and its position in the real world. The learned relationship may then be used by the object detection and localization model 106 to predict the position of an object in a new image or video. Output of the object detection and localization model 106 may be useful for locating objects that are not visible in the image or video, such as objects that are partially obscured or objects that are located behind other objects.

In an aspect, the object position database 206 may be a database that stores the position of objects in the real world. The information stored in the object position database 206 may be used for a variety of purposes, such as, but not limited to: object tracking, object detection, 3D modeling, virtual reality, and the like. Object tracking is the process of identifying and tracking the movement of objects over time. The object position database 206 may be used to track the movement of objects by storing their position at regular intervals. Object detection is the process of identifying and locating objects in images or videos. The object position database 206 may also be used to improve the accuracy of object detection by providing information about the expected position of objects in the scene. 3D modeling is the process of creating a 3D representation of an object or scene.

In an aspect, the object detection and localization model 106 may perform two stages: object detection and object localization. The object detection stage may identify the presence of objects in the image or video. In an aspect, the presence of objects may be done by the object detection and localization model 106 first identifying regions of interest (ROIs) in the image or video that are likely to contain objects. Then, the object detection and localization model 106 may use a classifier to classify each ROI as containing a specific object or not containing an object. The object localization stage may identify the location of each object that was detected in the object detection stage. In an aspect, the location of each object may be identified by the object detection and localization model 106 predicting a bounding box of each object. The bounding box may be a rectangle, or other polygonal shape, that encloses the object in the image or video. In an aspect, the object detection and localization model 106 may generate a plurality of bounding boxes (e.g., respective bounding box for each object) which may be used both for object detection and localization.

In an aspect, the object detection and localization model 106 may be configured to perform automatic feature extraction and inference 208. Automatic feature extraction is the process of identifying and extracting features from data without human intervention. In an aspect, the automatic feature extraction and inference 208 may involve the following steps: image preprocessing, feature extraction and feature selection. In an aspect, the object detection and localization model 106 may preprocess the image to remove noise and improve the contrast.

In an aspect, the automatic inference process may involve the following steps: classification and localization. The features may be classified into different categories, such as “object” or “background.” The location of each object may be predicted by the object detection and localization model 106, such as its bounding box or centroid.

FIG. 2 illustrates output of the object detection and localization model 106. In an aspect, the output may include an output image 210 (output data 112 in FIG. 1) showing the estimated position of the object of interest. More specifically, the output image 210 may show estimated geographical position(s) of one or more poles 212. The output image 210 may further include utility company reported position(s) 214. In the case illustrated in FIG. 2, magnitude of correction 216 may be equal to approximately 2.5 meters.

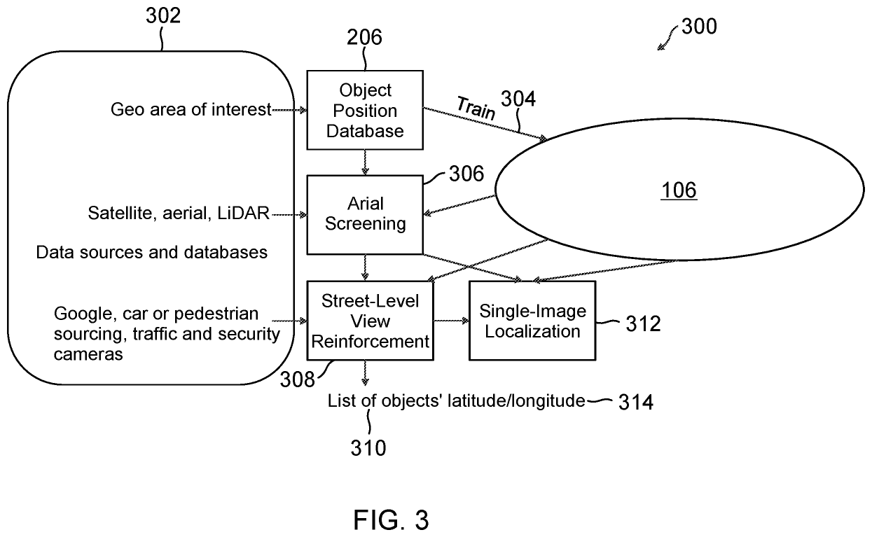

FIG. 3 is a block diagram illustrating an exemplary processing flow 300 in accordance with the techniques of this disclosure. In an aspect, there may be a variety of data sources and databases 302 that may be used for object detection and localization. The aforementioned data sources may be classified into two main categories: remote sensing data and in-situ data.

In an aspect, remote sensing data may be collected from a distance, such as from satellites, aerial vehicles, or LIDAR sensors. Remote sensing data may be used by the object detection and localization model 106 to create a 3D model of the environment, which may then be used to identify and locate objects. In-situ data may be collected from the ground, such as from cameras, sensors, or human annotators. In-situ data may be used to label objects in images or videos, which may then be used to train object detection and localization models. Some specific examples of data sources and databases 302 that may be used for object detection and localization may include, but are not limited to: geo area of interest, satellite data, aerial data, LIDAR sensor data, Google Street View data, car or pedestrian sourcing data, traffic and security cameras, object position database 206 and the like. Geo area of interest data may be used to define the area of interest for object detection and localization. Geo area of interest data may be useful for applications such as traffic monitoring or security surveillance. Satellite data may be used to create a 3D model of the environment. Satellite data may then be used to identify and locate objects, such as, but not limited to, poles, buildings, vehicles, and people. Aerial data may also be used to create a 3D model of the environment. Aerial data may be collected from drones or other aerial vehicles. LIDAR sensor data may be used to create a 3D point cloud of the environment. LIDAR sensor data may be used to identify and locate objects, such as, but not limited to, buildings, vehicles, and people. Google Street View data may be used to collect images of the environment from street level. Google Street View data may be used to identify and locate objects, such as, but not limited to, vehicles, people, and buildings. Car or pedestrian sourcing data may be used to collect images or videos of the environment from moving vehicles or pedestrians. Traffic and security cameras may also be used to collect images or videos of the environment. The choice of data sources and databases 302 may depend on the specific application. For example, if the application is traffic monitoring, then satellite data may be a good choice. If the application is security surveillance, then traffic and security cameras may be a good choice.

In an aspect, the object position database 206 may include a database that stores the position of objects in the real world. In an aspect, the information in the object position database 206 may be obtained from the data sources and databases 302. The information stored in the object position database 206 may be used for a variety of purposes, such as, but not limited to: object tracking, object detection, 3D modeling, virtual reality, and the like.

In an aspect, the data in the object position database 206 may be used to train the object detection and localization model 106 for area-specific object features in a few ways. The object detection and localization model 106 may use the data in the object position database 206 to extract features that are specific to the area. For example, the data could be used to extract features such as, but not limited to, the average height of objects in the area, the average width of objects in the area, and the average distance between objects in the area. The object detection and localization model 106 may use the data in the object position database 206 to label objects with their area-specific features. For example, the data in the object position database 206 may be used to label objects with their type (e.g., pole, car, person, building), their size, and their color. The data in the object position database 206 may be used to train 304 the object detection and localization model 106 to identify and classify objects based on their area-specific features. For example, the object position database 106 could be trained to identify poles, cars, people, and buildings based on their height, width, and distance from each other. Once the object detection and localization model 106 is trained, it may be used to identify and classify objects in new images or videos that are taken in the same area. Classification of objects may be useful for a variety of applications, such as, but not limited to, security, surveillance, and navigation. At least some of the benefits of using the object position database 206 to train 304 the object detection and localization model 106 for area-specific object features may include, but are not limited to: increased accuracy, reduced training time and improved safety.

In an aspect, the object detection and localization model 106 may comprise a YOLO model. YOLO is an object detection algorithm that may detect objects in real time. YOLO algorithm may divide the image into a grid of cells and may predict bounding boxes and class probabilities for each cell. The bounding boxes may be predicted using a single neural network, which makes YOLO implementation very fast.

In an aspect, the object detection and localization model 106 may use information in the data sources and databases 302 and the object position database 206 to perform aerial screening 306. Aerial screening 306 is the process of using aircraft or drones to take pictures and/or video of an area of interest from above. Generally, aerial screening 306 may be used for a variety of purposes, including, but not limited to: security, search and rescue, environmental monitoring, agriculture, mapping, surveying, and the like. The aerial screening 306 may also be used to create maps of an area. The aerial screening 306 may also be used to survey an area for construction or development projects. Overall, the aerial screening 306 may be a valuable tool for a variety of applications. The aerial screening 306 may be used by the object detection and localization model 106 to quickly and efficiently process pictures of a large area, and it may provide valuable information that would not be possible to obtain from the pictures/videos taken from the ground.

In an aspect, the object detection and localization model 106 may use the information obtained from processing results of the aerial screening 306 as well as the information stored in the data sources and databases 302 to perform street level view reinforcement 308. The street-level view reinforcement 308 is the process of improving the quality of position predictions. The street level view reinforcement 308 may be performed by the object detection and localization model 106 using a variety of methods, such as, but not limited to, image stitching, object detection and localization, semantic segmentation, depth estimation, and the like. Image stitching is the process of combining multiple images to create a wider or more detailed view. Object detection and localization is the process of identifying and locating objects in images. Object detection and localization may be helpful for adding labels to street-level views or for identifying objects of interest. In an aspect, the street level view reinforcement 308 may generate a list of identified objects 310.

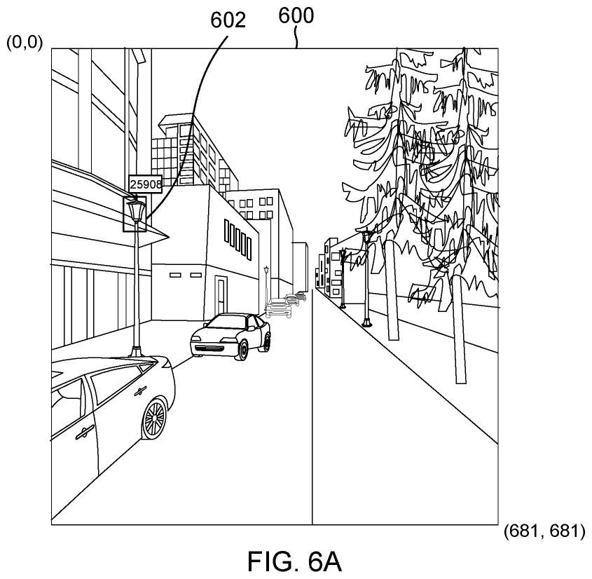

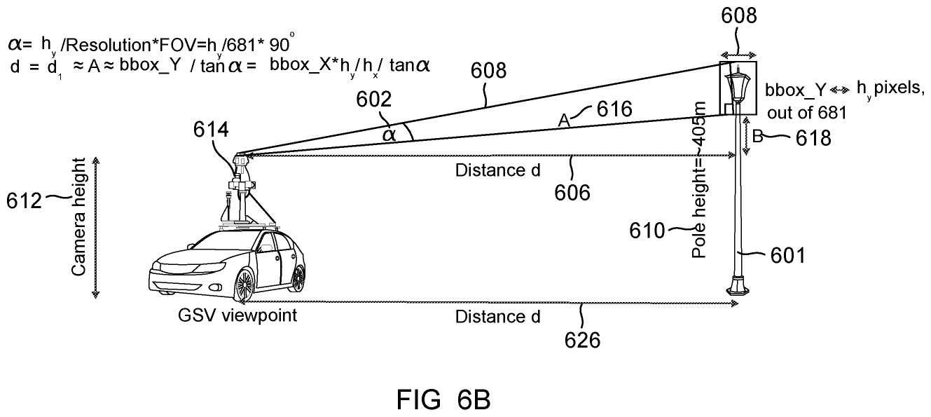

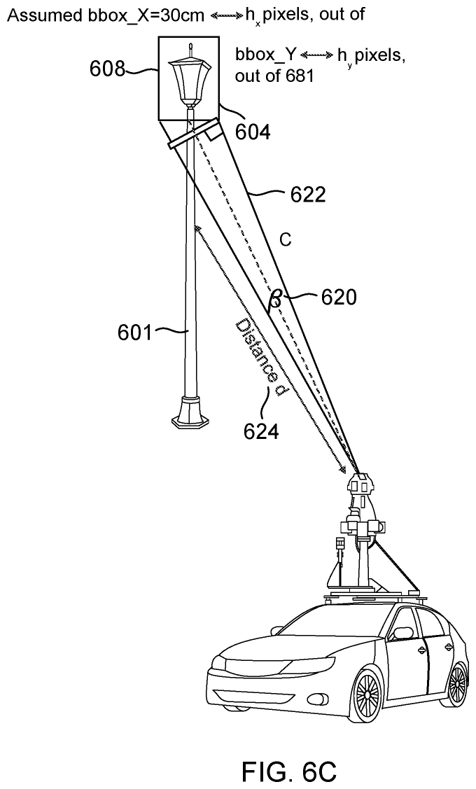

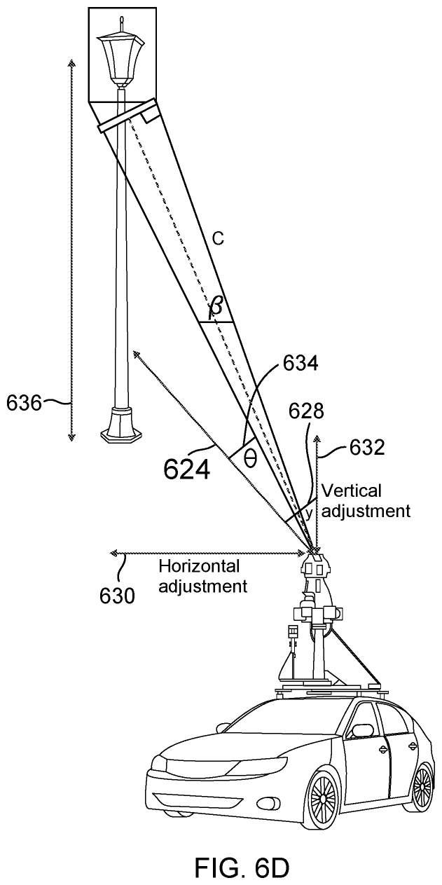

In an aspect, if multiple street-level images are not available, the object detection and localization model 106 may perform single image localization 312. In an aspect, the single image localization 312 may enable the object detection and localization model 106 to reliably infer position and height of the object of interest (e.g., pole). There are a number of factors that may affect the accuracy of the inference, including, but not limited to: the quality of the image, the size of the object, the background clutter, and the like. It is desirable for the single image to be high-resolution and be well-lit in order to accurately identify the object and its features. The size of the object relative to the camera may affect the accuracy of the inference. The background clutter and the object's surroundings may make it difficult to identify the object and its features, such as if the object is located in a crowded environment or if it is partially obscured by other objects. Despite these challenges, the object detection and localization model 106 may reliably infer the position and height of the object based on a single image, as described below in conjunction with FIGS. 6A-6D. In an aspect, the single image localization 312 may generate estimation of the object position 314 (e.g., in the form of latitude and longitude).

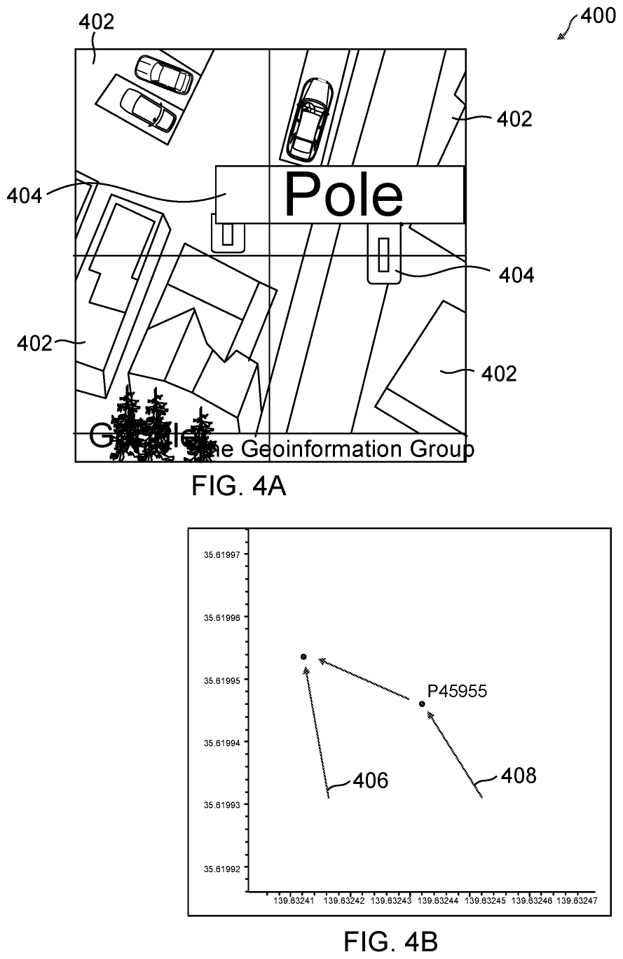

FIGS. 4A and 4B are diagrams illustrating an example of the aerial screening 306 in accordance with the techniques of this disclosure. In an aspect, the object detection and localization model 106 may use an aerial screening sliding window scan to perform the aerial screening 306. An aerial screening sliding window scan is a technique used to search for objects of interest in aerial imagery 400. The technique works by dividing the aerial imagery 400 into a grid of smaller windows 402, and then scanning each window 402 for objects of interest. If an object of interest is found in window 402, then the object detection and localization model 106 may zoom in on that window to get a closer look. The sliding window scan may be used to search for a variety of objects, such as, but not limited to, poles vehicles, people, and buildings. The sliding window scan may also be used to search for objects that are not visible in the entire aerial imagery 400, such as objects that are partially obscured by other objects. The sliding window scan is a powerful technique for aerial screening, but this scan may be computationally expensive. The number of windows that need to be scanned increases as the size of the aerial imagery 400 increases. Additionally, the sliding window scan can be slow if the aerial imagery 400 is high-resolution. To reduce the computational cost of the sliding window scan, the object detection and localization model 106 may use the sliding window scan in conjunction with the object position database 206. The object position database 206 may be used by the object detection and localization model 106 to initialize the scan by identifying areas of the aerial imagery 400 that are likely to contain objects of interest (e.g., poles). The object position database 206 may help to focus the scan on the areas that are most likely to contain objects of interest and may reduce the number of windows 402 that need to be scanned by the object detection and localization model 106.

In an aspect, in order to perform the aerial screening sliding window scan, the object detection and localization model 106 may first retrieve the aerial imagery 400 across a grid of selected locations. Retrieving the aerial imagery 400 that may comprise one or more aerial view images across a grid of selected locations may be done using the following steps. The first step may involve defining by the object detection and localization model 106 the grid of selected locations. In an aspect, the grid of selected locations may be defined by specifying the coordinates of the grid points. The next step may involve the object detection and localization model 106 identifying the aerial imagery providers that have imagery of the selected locations. The object detection and localization model 106 may perform provider identification, for example, by searching the data sources and databases 302 for aerial imagery providers that cover the area of interest. Once the aerial imagery providers have been identified, the object detection and localization model 106 may retrieve the aerial imagery 400.

Next, the object detection and localization model 106 may perform bounding box marking. Bounding-box marking is a process of using machine learning to identify and mark bounding boxes around objects in images. As noted above, the object detection and localization model 106 may comprise a YOLO model. The YOLO algorithm works by dividing the image into a grid of cells. Each cell may predict a set of bounding boxes and confidence scores for each object class. The confidence score may indicate how likely it is that the bounding box contains an object of the specified class. The bounding boxes predicted by the object detection and localization model 106 may not always be accurate. To improve the accuracy of the bounding boxes, the object detection and localization model 106 may refine the bounding boxes using a technique called non-maximum suppression. Non-maximum suppression may remove overlapping bounding boxes that are likely to contain the same object.

In an aspect, the object detection and localization model 106 may complete the aerial screening 306 by localizing bounding boxes with respect to the zoomed image dimensions and geographical positions. In an aspect, the object detection and localization model 106 may localize (determine positions of) the bounding boxes using the following steps. During the first step, the object detection and localization model 106 may determine the zoom level of the image. The zoom level of the image may be determined by calculating the ratio between the original image dimensions and the zoomed image dimensions. Once the zoom level has been determined, the object detection and localization model 106 may calculate the bounding box coordinates. In an aspect, the object detection and localization model 106 may calculate the bounding box coordinates by multiplying the original bounding box coordinates by the zoom factor. The bounding box coordinates may then be converted to geographical positions by the object detection and localization model 106 using a geolocation Application Programming Interface (API), for example. In an aspect, as a result of the aerial screening 306, the object detection and localization model 106 may identify one or more bounding boxes 404 containing an object of interest (e.g., a pole) as well as estimated geographical position of the object of interest. As shown in FIG. 4B, the estimated geographical position 406 (output data 112 in FIG. 1) generated by the object detection and localization model 106 may be different from the estimated geographical position 408 provided by the object position database 206 during initialization, for example.

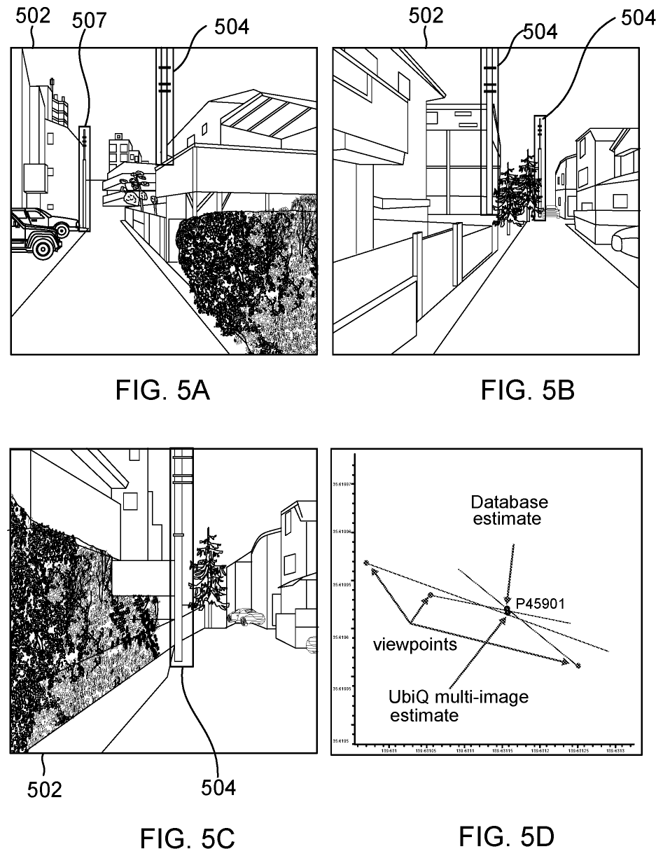

FIGS. 5A-5D are diagrams illustrating an example of street level view reinforcement 308 in accordance with the techniques of this disclosure. In an aspect, as described above with respect to FIGS. 4A and 4B, object detection and localization model 106 may determine the one or more bounding boxes 404 may identify the poles in the aerial imagery 400. With respect to FIGS. 5A-5D, once the poles have been identified, the object detection and localization model 106 may retrieve the street-level images 502 from the data sources and databases 302, for example. In an aspect, the data sources and databases 302 may include a plurality of sources of the street-level images. Such sources may include, but not limited to: Google Street View, car sourcing, existing cameras, and the like. Google Street View may provide street-level images of many cities around the world. Car sourcing companies may provide street-level images of roads and highways. Existing cameras, such as traffic cameras or security cameras, may also be used to retrieve the street-level images 502. In an aspect, the retrieved street-level images 502 may need to be filtered by the object detection and localization model 106 to only include images that contain the poles. In an aspect, the object detection and localization model 106 may filter the retrieved street level images 502 based on one or more bounding boxes 404. It should be noted that the availability of street-level images 502 may vary depending on the location of the poles. In some areas, there may be no street-level images 502 available. The quality of the street-level images 502 may vary depending on the source of the images. Some sources, such as Google Street View, may provide high-quality images, while others may provide lower-quality images.

Next, the object detection and localization model 106 may perform bounding box marking once again for the street-level images 502. Bounding-box marking is a process of using machine learning to identify and mark bounding boxes around objects in images. As noted above, the object detection and localization model 106 may comprise a YOLO model. The YOLO algorithm works by dividing the image into a grid of cells. Each cell may predict a set of bounding boxes and confidence scores for each object class. The confidence score may indicate how likely it is that the bounding box contains an object of the specified class. The bounding boxes predicted by the object detection and localization model 106 may not always be accurate. To improve the accuracy of the bounding boxes, the object detection and localization model 106 may refine the bounding boxes using a technique called non-maximum suppression. Non-maximum suppression may remove overlapping bounding boxes that are likely to contain the same object. In an aspect, the object detection and localization model 106 may use the bounding box marking for object detection. In other words, the bounding-box marking may be used by the object detection and localization model 106 to identify and locate objects (e.g., poles) in the street-level images 502. It should be noted that machine learning-based bounding-box marking may also be used to track the movement of objects over time. Advantageously, the bounding box marking is a fast and efficient way to identify and mark objects in images. In an aspect, the bounding box marking may be used to improve the accuracy of bounding boxes 504 by using non-maximum suppression.

In an aspect, the object detection and localization model 106 may complete the street level view reinforcement by triangulating a plurality of bounding boxes 504 from a plurality of the street-level images 502, as shown in FIG. 5D. In an aspect, triangulation of the bounding boxes 504 from multiple street-level images 502 may be done using the following steps. The first step may involve identifying by the object detection and localization model 106 the bounding boxes 504 in each street-level image 502. Such identification may be performed using a variety of methods, such as, but not limited to, object detection algorithms or manual labeling. Once the bounding boxes 504 have been identified in each image 502, the object detection and localization model 106 may match the bounding boxes 504 across images. Image matching algorithms may be used by the object detection and localization model 106 to match bounding boxes 504 across street-level images 502 by comparing the street-level images 502 to each other. In an aspect, the object detection and localization model 106 may use object detection algorithms to match bounding boxes 504 across the street-level images 502 by identifying the same object in multiple street-level images 502. Once the bounding boxes 504 have been matched across the street-level images 502, the object detection and localization model 106 may perform triangulation to estimate the 3D position of the object. Triangulation is a mathematical technique that may be used to estimate the position of an object from the known positions of three points, as shown in FIG. 5D.

It should be noted that the quality of the street-level images 502 may affect the accuracy of the triangulation. The street-level images 502 with low resolution or poor lighting may make it more difficult for the object detection and localization model 106 to triangulate the bounding boxes 504. The more street-level images 502 that are available, the more accurate the triangulation performed by the object detection and localization model 106 may be. However, it may not always be possible to obtain a large number of street-level images 502 of the same object.

FIGS. 6A-6D are diagrams illustrating an example of single image localization in accordance with the techniques of this disclosure. As noted above, it may not be always possible to obtain a sufficient number of street level images 502 of the same object, which may make triangulation of the bounding boxes 504 inaccurate or obsolete. In an aspect, as an alternative to triangulation, the object detection and localization model 106 may perform localization based on a single image as described below. FIG. 6A illustrates an example of a single image 600. In an aspect, the image 600 may be obtained from Google Street View, for example, by the object detection and localization model 106. The image 600 may include a bounding box 602 containing a pole head. For illustrative purposes only, assume that parameters of the image 600 are as follows: resolution=681×681 pixels, Field of View (FOV) is 90 degrees in both X and Y directions, camera height is 2.5 meters and estimated bounding box width may be 30 cm. In an aspect, the object detection and localization object 106 may perform localization by performing the following steps: dimensioning the street object based on the image's “side” view, dimensioning based on the image's “front” view, averaging dimensioning across the two viewpoints estimates and inferring the object's geographical location. As used herein, the term “dimensioning” refers to inferring position and height of an object of interest.

FIG. 6B illustrates dimensioning based on the image's side view. In an aspect, the object detection and localization model 106 may calculate the angle of elevation to the pole (α) 602, given the height of the pole bounding box (h_{y}) 604, the resolution of the image (Resolution), and the field of view of the camera (FOV) using the following equation (2):

$$α = {h}_{y} / Resolution * FOV \qquad ( 2 )$$

The angle of elevation 602 is the angle between the line of sight from the camera to the top of the pole 601 and the horizontal plane.

Next, the object detection and localization model 106 may calculate the distance 606 to the pole 601, given the angle of elevation to the pole (α) 602, and the height of the bounding box of the pole (h_{y}) 604 using the following equation (3):

$$d = d 1 \approx A \approx bbox\_Y / tan α \qquad ( 3 )$$

The distance 606 to the pole 601 may be calculated by first calculating the distance 609 to the top of the pole 601 using the angle of elevation 602 and the height 610 of the pole 601. The distance 609 to the top of the pole 601 may then be multiplied by the ratio of the width of the bounding box 608 of the pole to the height of the bounding box 604 of the pole 601.

In an aspect, if the pole's height 610 is known (e.g., from GIS database), the object detection and localization model 106 may calculate a more precise estimate of the distance 606 using the following formulas (4) and (5):

$$B = PoleHeight - CameraHeight - bbox\_Y \qquad ( 4 )$$

where PoleHeight 610 is the known height of the pole 601, CameraHeight 612 is the height of the camera 614, and bbox_Y 604 is the height of the bounding box of the pole 601. In other words, the height of the pole 601 above the camera may be calculated by subtracting the height of the camera 612 from the height 610 of the pole and then subtracting the height of the bounding box 604 of the pole 601.

$$d = d 2 \approx \sqrt{{A}^{2} - {B}^{2}} d = d 2 \approx \sqrt{{A}^{2} - {B}^{2}} \qquad ( 5 )$$

where A is the distance 616 to the top of the pole 601, and B is the height 618 of the pole 601 above the camera 614. In other words, the distance 606 to the pole 601 may be calculated by taking the square root of the difference between the square of the distance 616 to the top of the pole 601 and the square of the height 618 of the pole 601 above the camera 614, using Pythagorean theorem, as shown in FIG. 6B.

FIG. 6C illustrates dimensioning based on the image's front view. In an aspect, the object detection and localization object 106 may calculate the angle of elevation to the top of the pole (β) 620 using the following equation (6):

$$β = {h}_{x} / Resolution * FOV \qquad ( 6 )$$

where hₓ is the width of the bounding box 608, Resolution is the resolution of the image, and FOV is the field of view of the camera. The angle of elevation 620 is the angle between the line of sight from the camera to the top of the pole 601 and the horizontal plane.

Next, the object detection and localization model 106 may calculate the distance 622 to the top of the pole 601 using the following equation (7):

$$C \approx bbox\_X / tan β \qquad ( 7 )$$

where bbox_X is the width of the bounding box 608 of the pole 601, β 620 is the angle of elevation to the top of the pole 601. The distance 622 to the top of the pole 601 may then be multiplied by the ratio of the width of the bounding box 608 of the pole 601 to the height of the bounding box 604 of the pole 601.

In an aspect, the object detection and localization model 106 may calculate the distance 624 to the pole 601 using the following equation (8):

$$d = d 1 \approx \sqrt{{C}^{2} + {( bbox\_X / 2 )}^{2}} \qquad ( 8 )$$

where C is the distance 622 to the top of the pole 601 and bbox_X/2 is the half-width of the bounding box 608 of the pole 601. In other words, the distance 624 to the pole 601 may be calculated by taking the square root of the sum of the squares of the distance 622 to the top of the pole 601 and the square of half the width of the bounding box 608 of the pole 601.

In an aspect, if the pole's height 610 is known (e.g., from GIS database), the object detection and localization model 106 may get a more precise estimate of the distance using the formula (4) above and the following formula (9):

$$d = d 2 \approx \sqrt{d {1}^{2} - {B}^{2}} \qquad ( 9 )$$

where d1 is the distance 622 to the top of the pole 601, and B is the height 610 of the pole 601 above the camera 614. In other words, the distance 624 to the pole 601 may be calculated by taking the square root of the difference between the square of the distance 622 to the top of the pole 601 and the square of the height 610 of the pole 601 above the camera 614, as shown in FIG. 6C.

FIG. 6D illustrates averaging across two viewpoints estimates. In an aspect, the object detection and localization object 106 may calculate the distance from GSV viewpoint 626 (shown in FIG. 6B) to pole locations as the average of distances calculated by formulas (3) and (5) above. For the front view case (shown in FIG. 6C), the object detection and localization object 106 may calculate the distance 624 as the average of distances calculated by formulas (8) and (9) above. In an aspect, the object detection and localization model 106 may calculate the angle of elevation to the top of the pole (γ) 628 using the following equation (10):

$$γ = ( \frac{x}{Resolution} - \frac{1}{2} ) * FOV \qquad ( 10 )$$

where x is the x-coordinate of the pole 601 in the image, Resolution is the resolution of the image and FOV is the field of view of the camera. The angle of elevation 628 is the angle between the line of sight from the camera to the top of the pole 601 and the horizontal plane.

Next, the object detection and localization model 106 may calculate the horizontal adjustment 630 to the dimensions of the pole (horzAdjust) using the following formula (11):

$$horzAdjust = d s in γ \qquad ( 11 )$$

where d is the distance 624 to the pole 601 and γ is the angle of elevation 628 to the top of the pole 601. The horizontal adjustment 630 is the amount by which the dimensions of the pole 601 need to be adjusted to account for the fact that the pole 601 is not perfectly vertical.

Next, the object detection and localization model 106 may calculate the vertical adjustment 632 to the dimensions of the pole (vertAdjust) using the following formula (12):

$$vertAdjust = d cos γ \qquad ( 12 )$$

where d is the distance 624 to the pole 601 and γ is the angle of elevation 628 to the top of the pole 601. The vertical adjustment 632 is the amount by which the dimensions of the pole 601 need to be adjusted to account for the fact that the pole 601 is not perfectly perpendicular to the ground.

In an aspect, the object detection and localization model 106 may calculate the angle of depression to the bottom of the pole (θ) 634 using the following formula (13):

$$θ = ( \frac{1}{2} - \frac{y}{Resolution} ) * FOV \qquad ( 13 )$$

where y is the y-coordinate of the pole 601 in the image, Resolution is the resolution of the image and FOV is the field of view of the camera. The angle of depression 634 is the angle between the line of sight from the camera to the bottom of the pole 601 and the horizontal plane.

Finally, the object detection and localization model 106 may calculate the height of the pole (Height) 636 using the following formula (14):

$$Height = d tan θ + CameraHeight \qquad ( 14 )$$

where d is the distance 624 to the pole 601, 0 is the angle of depression 634 to the bottom of the pole 601 and CameraHeight is the height 612 of the camera above the ground. In formula (14) the height 636 of the pole 601 is calculated using the tangent function.

In an aspect, the object detection and localization model 106 may translate the horizontal adjustment 630 and the vertical adjustment 632 to geographic coordinates (i.e., terms of latitude and longitude) according to the known heading (i.e., north/east/south/west) of the image. The horizontal adjustment 630 may be translated to latitude by multiplying it by the cosine of the heading angle. The vertical adjustment 632 may be translated to longitude by multiplying it by the sine of the heading angle. For example, if the heading angle is north (0 degrees), then the horizontal adjustment 630 will have no effect on the latitude, and the vertical adjustment 632 will simply be the longitude adjustment. If the heading angle is cast (90 degrees), then the horizontal adjustment 630 will simply be the latitude adjustment, and the vertical adjustment 632 will have no effect on the longitude.

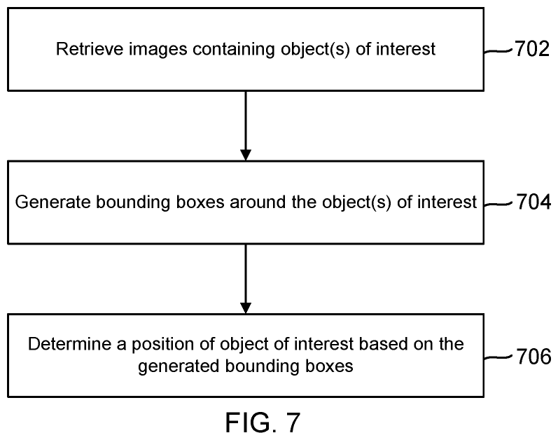

FIG. 7 is a flowchart illustrating an example method for digital twin localization in accordance with the techniques of this disclosure. Although described with respect to computing system 100 (FIG. 1), it should be understood that other devices may be configured to perform a method similar to that of FIG. 7.

In this example, machine learning system 204 may initially retrieve a plurality of images containing one or more objects of interest (702). In an aspect, the plurality of images may be obtained from the data sources and databases 302. The plurality of images may include aerial and street-level images. Next, the object detection and localization model 106 may generate bounding boxes around the object of interest for each of the plurality of images by performing bounding box marking (704). For example, the object detection and localization model 106 may use a YOLO algorithm for bounding box marking. The YOLO algorithm works by dividing the image into a grid of cells. Each cell may predict a set of bounding boxes and confidence scores for each object class. The object detection and localization model 106 may then determine a position of the object of interest based on the generated bounding boxes using one or more images (706). In an aspect, the object detection and localization model may perform object localization based on both aerial (top view) images and street-level images. Furthermore, the object detection and localization model 106 may perform object localization based on either multiple or single image data in a given geographical area of interest.

The following numbered clauses illustrate one or more aspects of the devices and techniques described in this disclosure.

Clause 1. A method comprising: retrieving a plurality of images containing one or more objects of interest; generating, with one or more processors, using a machine learning model, a bounding box around each of the one or more objects of interest for each of the plurality of images; and determining, with the one or more processors, a geographical position of each of the one or more objects of interest based on a position of the bounding box.

Clause 2—The method of clause 1, wherein the plurality of images include at least: one or more street-level images of the one or more objects of interest and one or more aerial view images of the one or more objects of interest.

Clause 3—The method of clause 2, wherein generating the bounding box further comprises generating, with the one or more processors, the bounding box around each of the one or more objects of interest for a grid of selected locations for the one or more aerial view images.

Clause 4—The method of clause 3, wherein generating the bounding box around each of the one or more objects of interest for the grid of selected locations further comprises identifying, with the one or more processors, one or more aerial imagery providers that have the one or more aerial view images of the selected locations.

Clause 5—The method of clause 1, wherein generating the bounding box around each of the one or more objects of interest for the grid of selected locations further comprises identifying, with the one or more processors, one or more aerial imagery providers that have the one or more aerial view images of the selected locations.

Clause 6—The method of clause 1, wherein determining the geographical position of each of the one or more objects of interest further comprises triangulating, with the one or more processors, positions of a plurality of bounding boxes associated with two or more street-level images of the one or more objects of interest.

Clause 7—The method of clause 6, wherein triangulating the positions of the plurality of bounding boxes further comprises matching, with the one or more processors, the plurality of bounding boxes across the two or more street-level images.

Clause 8—The method of any of clauses 1-7, wherein the machine learning model comprises a pre-trained single stage detection model.

Clause 9—The method of clause 8, wherein the machine learning model comprises a You Only Look Once (YOLO) model.

Clause 10—The method of any of clauses 1-7, wherein the one or more objects of interest comprise one or more virtual representations of one or more physical objects.

Clause 11—The method of any of clauses 1-7, wherein determining the geographical position of each of the one or more objects of interest further comprises determining, with the one or more processors, using a single street-level image, a distance between each of the one or more objects of interest and a camera used to capture the single street-level image.

Clause 12—The method of any of clauses 1-7, wherein determining the geographical position of each of the one or more object of interest further comprises: determining, with the one or more processors, a horizontal adjustment to the geographical position; and determining, with the one or more processors, a vertical adjustment to the geographical position.

Clause 13—An apparatus for object localization, the apparatus comprising a memory for storing a plurality of images containing one or more objects of interest; and processing circuitry in communication with the memory, wherein the processing circuitry is configured to: retrieve the plurality of images containing the one or more objects of interest; generate, using a machine learning model, a bounding box around each of the one or more objects of interest for each of the plurality of images; and determine a geographical position of each of the one or more objects of interest based on a position of the bounding box.

Clause 14—The apparatus of clause 13, wherein the plurality of images include at least: one or more street-level images of the one or more objects of interest and one or more aerial view images of the one or more objects of interest.

Clause 15—The apparatus of clause 14, wherein the processing circuitry configured to generate the bounding box is further configured to generate the bounding box around each of the one or more objects of interest for a grid of selected locations for the one or more aerial view images.

Clause 16—The apparatus of clause 15, wherein the processing circuitry configured to generate the bounding box around each of the one or more objects of interest for the grid of selected locations is further configured to identify one or more aerial imagery providers that have the one or more aerial view images of the selected locations.

Clause 17—The apparatus of clause 13, wherein the processing circuitry configured to determine the geographical position of each of the one or more objects of interest is further configured to determine geographical coordinates of each of the one or more objects of interest.

Clause 18—The apparatus of clause 13, wherein the processing circuitry configured to determine the geographical position of each of the one or more objects of interest is further configured to triangulate positions of a plurality of bounding boxes associated with two or more street-level images of the one or more objects of interest.

Clause 19—The apparatus of clause 18, wherein the processing circuitry configured to triangulate the positions of the plurality of bounding boxes is further configured to match the plurality of bounding boxes across the two or more street-level images.

Clause 20—A computer-readable medium storing instructions that, when applied by processing circuitry, causes the processing circuitry to: retrieve the plurality of images containing the one or more objects of interest; generate, using a machine learning model, a bounding box around each of the one or more objects of interest for each of the plurality of images; and determine a geographical position of each of the one or more objects of interest based on a position of the bounding box.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware. Various examples have been described. These and other examples are within the scope of the following claims.

What is claimed is:

1. A method comprising:
retrieving a plurality of images containing one or more objects of interest;
generating, with one or more processors, using a machine learning model, a bounding box around each of the one or more objects of interest for each of the plurality of images; and
determining, with the one or more processors, a geographical position of each of the one or more objects of interest based on a position of the bounding box.

2. The method of claim 1, wherein the plurality of images include at least: one or more street-level images of the one or more objects of interest and one or more aerial view images of the one or more objects of interest.

3. The method of claim 2, wherein generating the bounding box further comprises generating, with the one or more processors, the bounding box around each of the one or more objects of interest for a grid of selected locations for the one or more aerial view images.

4. The method of claim 3, wherein generating the bounding box around each of the one or more objects of interest for the grid of selected locations further comprises identifying, with the one or more processors, one or more aerial imagery providers that have the one or more aerial view images of the selected locations.

5. The method of claim 1, wherein determining the geographical position of each of the one or more objects of interest further comprises determining, with the one or more processors, geographical coordinates of each of the one or more objects of interest.

6. The method of claim 1, wherein determining the geographical position of each of the one or more objects of interest further comprises triangulating, with the one or more processors, positions of a plurality of bounding boxes associated with two or more street-level images of the one or more objects of interest.

7. The method of claim 6, wherein triangulating the positions of the plurality of bounding boxes further comprises matching, with the one or more processors, the plurality of bounding boxes across the two or more street-level images.

8. The method of claim 1, wherein the machine learning model comprises a pre-trained single stage detection model.

9. The method of claim 8, wherein the machine learning model comprises a You Only Look Once (YOLO) model.

10. The method of claim 1, wherein the one or more objects of interest comprise one or more virtual representations of one or more physical objects.

11. The method of claim 1, wherein determining the geographical position of each of the one or more objects of interest further comprises determining, with the one or more processors, using a single street-level image, a distance between each of the one or more objects of interest and a camera used to capture the single street-level image.

12. The method of claim 1, wherein determining the geographical position of each of the one or more object of interest further comprises:
determining, with the one or more processors, a horizontal adjustment to the geographical position; and
determining, with the one or more processors, a vertical adjustment to the geographical position.

13. An apparatus for object localization, the apparatus comprising:
a memory for storing a plurality of images containing one or more objects of interest; and
processing circuitry in communication with the memory, wherein the processing circuitry is configured to:
retrieve the plurality of images containing the one or more objects of interest;
generate, using a machine learning model, a bounding box around each of the one or more objects of interest for each of the plurality of images; and
determine a geographical position of each of the one or more objects of interest based on a position of the bounding box.

14. The apparatus of claim 13, wherein the plurality of images include at least: one or more street-level images of the one or more objects of interest and one or more aerial view images of the one or more objects of interest.

15. The apparatus of claim 14, wherein the processing circuitry configured to generate the bounding box is further configured to generate the bounding box around each of the one or more objects of interest for a grid of selected locations for the one or more aerial view images.

16. The apparatus of claim 15, wherein the processing circuitry configured to generate the bounding box around each of the one or more objects of interest for the grid of selected locations is further configured to identify one or more aerial imagery providers that have the one or more aerial view images of the selected locations.

17. The apparatus of claim 13, wherein the processing circuitry configured to determine the geographical position of each of the one or more objects of interest is further configured to determine geographical coordinates of each of the one or more objects of interest.

18. The apparatus of claim 13, wherein the processing circuitry configured to determine the geographical position of each of the one or more objects of interest is further configured to triangulate positions of a plurality of bounding boxes associated with two or more street-level images of the one or more objects of interest.

19. The apparatus of claim 18, wherein the processing circuitry configured to triangulate the positions of the plurality of bounding boxes is further configured to match the plurality of bounding boxes across the two or more street-level images.

20. A computer-readable medium storing instructions that, when applied by processing circuitry, causes the processing circuitry to:
retrieve the plurality of images containing the one or more objects of interest;
generate, using a machine learning model, a bounding box around each of the one or more objects of interest for each of the plurality of images; and
determine a geographical position of each of the one or more objects of interest based on a position of the bounding box.
